(19) United States
(12) Patent Application Publication
(10) Pub. No.: US 2026/0230712 A1
(43) Pub. Date: Aug. 6, 2026

(54) FLICKER COMPENSATION FOR MIXED LIGHTING CONDITIONS

(71) Applicant: Motorola Mobility LLC, Chicago, IL (US)

(72) Inventors: Ranjeet Gupta, Aurora, IL (US); Rahul Bharat Desai, Hoffman Estates, IL (US)

(73) Assignee: Motorola Mobility LLC, Chicago, IL (US)

(21) Appl. No.: 19/043,102

(22) Filed: Jan. 31, 2025

(51) Int. Cl. H04N 23/72; H04N 23/60; H04N 23/62; H04N 23/63; H04N 23/71; H04N 23/73; H04N 23/745; H04N 23/76

(52) U.S. Cl. CPC H04N 23/72; H04N 23/62; H04N 23/632; H04N 23/64; H04N 23/71; H04N 23/73; H04N 23/745; H04N 23/76

(57) ABSTRACT

A mobile device is operable to acquire data describing an environment of the mobile device and process the data using at least one machine-learning model trained to detect mixed illumination in the environment. The mixed illumination includes light emitted by two or more illumination sources at different output frequencies. Panoramic imaging is initiated based at least in part on the mixed illumination detected in the environment, and an image that compensates for the mixed illumination is generated from the panoramic imaging.

### BACKGROUND

As technology has advanced our uses for electronic devices have expanded. One such use is small mobile devices, such as smartphones, which have become increasingly powerful despite their small size. Such mobile devices often include image sensors and other components employed for digital imaging of subjects in various environments. However, such components can be susceptible to environmental lighting conditions and digital imaging quality may be degraded when pulsing or flickering lights are present in the imaged environment. One solution to this problem is to configure a mobile device to include a flicker sensor that detects fluctuations in environmental light intensity so that an exposure of an image sensor can be adjusted accordingly. However, this also has problems because situations arise in which flickering light is blended from multiple light sources. In such situations, the light intensity fluctuations from the light sources may be out of phase and irregular, and the flicker sensor may operate in an unpredictable manner. Adjustments to the exposure of the image sensor that are based on such irregular light intensity fluctuations may cause distortions and/or anomalies to appear in digital images generated by the mobile device. This can be frustrating for users, leading to user frustration with their devices.

### BRIEF DESCRIPTION OF THE DRAWINGS

Embodiments of mobile device conditional flicker compensation for mixed lighting conditions are described with reference to the following drawings. The same numbers are used throughout the drawings to reference like features and components:

FIG. 1 illustrates an example system implementing the techniques discussed herein;

FIG. 2 illustrates an example implementation of an illumination compensation system for mobile device conditional flicker compensation for mixed lighting conditions;

FIGS. 3-6 illustrate example stages of image acquisition using an image sensor as discussed herein;

FIG. 7 illustrates an example image acquired using an image sensor in an environment with mixed lighting conditions;

FIGS. 8-9 illustrate example input frequencies and output frequencies associated with light sources;

FIGS. 10-13 illustrate example output frequencies of different light sources;

FIGS. 14-16 illustrate different stages of imaging an environment with mixed lighting conditions in accordance with the described techniques;

FIGS. 17-19 illustrate example processes for implementing the techniques discussed herein in accordance with one or more embodiments;

FIG. 20 illustrates various components of an example mobile device that can implement embodiments of the techniques discussed herein.

### DETAILED DESCRIPTION

Mobile device conditional flicker compensation for mixed lighting conditions is discussed herein. Generally, a mobile device can be a portable electronic device such as a smartphone, a tablet, and so forth. The mobile device includes an image sensor and other components operable to support digital photography functionality. For example, the mobile device can be configured to acquire digital images of objects and other features within an environment of the mobile device using the image sensor. The mobile device can additionally include a flicker sensor to detect light intensity fluctuations within the environment. Based on the detected light intensity fluctuations, the mobile device can adjust operation of the image sensor to reduce a likelihood of banding and/or other visual aberrations in digital images acquired via the image sensor.

However, as mentioned above, some environmental conditions can result in undesired and/or unpredictable operation of the flicker sensor. As one example, during situations in which multiple light sources are present within the environment and operate with different output frequencies, irregular light intensity fluctuations can occur. Due to the irregularity of the light intensity fluctuations, the flicker sensor may be unable to determine a stable frequency associated with the fluctuations. As another example, light sources in the environment may output light at different intensities. A first light source may be associated with an increased intensity of light emission compared to a second light source. The difference in intensities may lead the flicker sensor to detect the frequency of light from the first light source and not detect the light from the second light source. However, the light from the second light source may have more light intensity fluctuations compared to the light from the first light source, which can contribute to visual aberrations and/or other degradations during imaging. As another example, the environment may include materials with refractive properties such as glass, plastics (e.g., acrylic), water, and so forth. Partial reflection and/or refraction of light by such materials can alter the frequency of the light. The altered light may blend with other light and may be detected by the flicker sensor as originating from a false duplicate light source. As another example, some light sources may employ pulse width modulation or other techniques for light dimming which can alter the output frequency of light and reduce an accuracy of detection of light intensity fluctuations by the flicker sensor.

The techniques discussed herein improve the operation of a mobile device by performing operations to increase imaging quality in conditions in which mixed illumination is detected within an environment. Such operations include deactivating a flicker sensor of the mobile device responsive to detection of mixed illumination in the environment and/or initiating panoramic imaging of the environment to acquire panoramic image data. The panoramic image data is used to generate an output image depicting the environment without banding or other image aberrations. To do so, one or more image frames included by the panoramic image data may be selected as a basis for generation of the output image. In some implementations, the one or more image frames may be selected such that the image frames depict the environment without depicting the mixed illumination. In some instances, the one or more image frames may be composited to form the output image without the banding or other image aberrations. “Mixed illumination” refers to illumination that is mixed (e.g., blended) from at least two illumination sources (e.g., illumination sources spaced apart from each other) and output by the illumination sources at different frequencies. As one example, mixed illumination includes light emitted from a first illumination source at a first frequency mixed with light emitted from a second illumination source at a second frequency.

Consider a scenario in which a user initiates imaging of an environment using an image sensor of a mobile device. To do so, user input is provided to the mobile device by way of pressing one or more physical buttons of the mobile device, selecting a graphical user interface element displayed by the mobile device, and the like. Responsive to receiving the user input, an illumination compensation system of the mobile device detects illumination sources within an environment of the mobile device and determines whether the environment includes mixed illumination. In this example scenario, the environment includes a first illumination source and a second illumination source, and the first illumination source emits light at a first frequency while the second illumination source emits light at a second frequency.

The illumination compensation system prompts the user to move the mobile device in a direction (e.g., rotate the mobile device to the right) until the first illumination source is within a field of view of the image sensor and the second illumination source is outside the field of view. The image sensor is employed to generate at least one image frame in this first position, and the flicker sensor can be used to adjust the image sensor exposure based on the output frequency of the first illumination source. The illumination compensation system then prompts the user to move the mobile device in the opposite direction (e.g., rotate the mobile device to the left). As the mobile device is moved, the field of view of the image sensor is also moved until the second illumination source is within the field of view and the first illumination source is outside the field of view. In this second position, the image sensor is employed to generate one or more additional image frames, and the flicker sensor can be used to adjust the image sensor exposure based on the output frequency of the second illumination source. The image frames generated in the first position and the second position are combined (e.g., composited) to form an image without banding or other image aberrations that would otherwise result from imaging the environment using conventional approaches.

During conditions in which mixed illumination is not detected within the environment, the flicker sensor is controlled to adjust an exposure timing and/or exposure duration used for imaging the environment. Therefore, operation of the mobile device for imaging the environment can be adjusted to increase imaging quality in a large variety of environmental lighting conditions. As a result, the techniques can reduce memory consumption associated with repeated imaging of the environment that may occur when imaging quality is unacceptable (e.g., due to banding or other aberrations) and support imaging of time-sensitive subjects (e.g., objects and/or humans moving through the environment) with increased imaging quality.

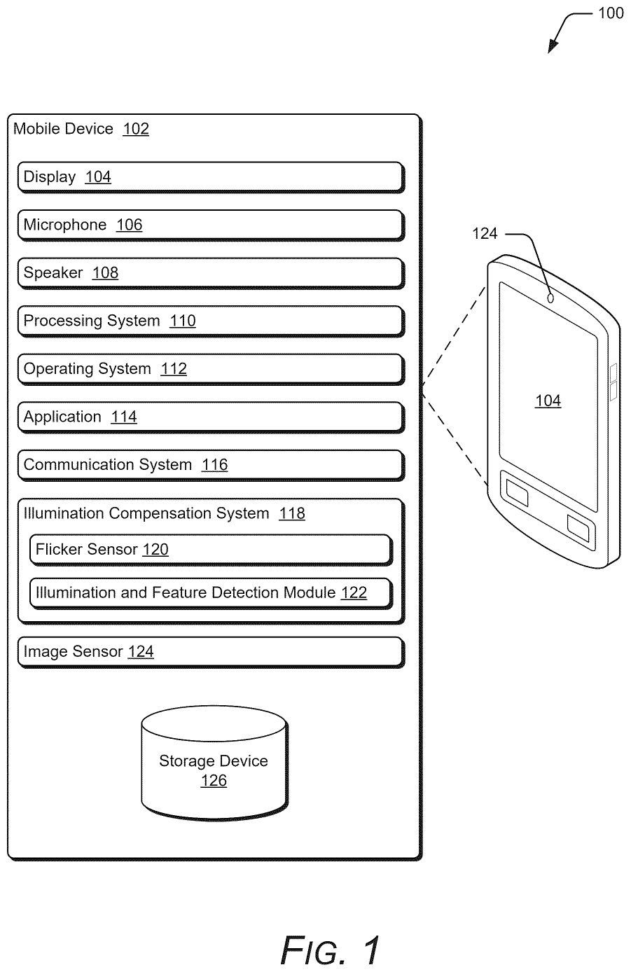

FIG. 1 illustrates an example system 100 implementing the techniques for mobile device conditional flicker compensation for mixed lighting conditions discussed herein. The system 100 includes a mobile device 102 that can be, or can include, many different types of computing or electronic devices. For example, the mobile device 102 can be a smartphone or other wireless phone, a camera (e.g., compact or single-lens reflex), a wearable device (e.g., a smartwatch, an augmented reality headset or device, a virtual reality headset or device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth. Although typically a smaller device, the mobile device 102 can be larger (e.g., a tablet or phablet computer, a notebook computer (e.g., netbook or ultrabook), a laptop computer, and so forth.

The display 104 can be configured as any suitable type of display, such as an organic light-emitting diode (OLED) display, active matrix OLED display, liquid crystal display (LCD), in-plane shifting LCD, and so forth. The display 104 can be touch enabled or not touch enabled. A touch-enabled device refers to a device that receives touch inputs via the display (e.g., a touchscreen). A touch-enabled device may also receive inputs via other input mechanisms, such as trackpad, mouse, physical keyboard, and so forth. A non-touch-enabled device refers to a device that does not receive touch inputs via the display (e.g., a touchscreen). Accordingly, a non-touch-enabled receives inputs via other input mechanisms, such as trackpad, mouse, physical keyboard, and so forth.

The mobile device 102 also includes a microphone 106 and a speaker 108. The microphone 106 can be configured as any suitable type of microphone incorporating a transducer that converts sound into an electrical signal, such as a dynamic microphone, a condenser microphone, a piezoelectric microphone, and so forth. The speaker 108 can be configured as any suitable type of speaker incorporating a transducer that converts an electrical signal into sound, such as a dynamic loudspeaker using a diaphragm, a piezoelectric speaker, non-diaphragm based speakers, and so forth.

The mobile device 102 also includes a processing system 110 that includes one or more processors, each of which can include one or more cores. The processing system 110 is coupled with, and may implement functionalities of, any other components or modules of the mobile device 102 that are described herein. In one or more embodiments, the processing system 110 includes a single processor having a single core. Alternatively, the processing system 110 includes a single processor having multiple cores or multiple processors (each having one or more cores).

The mobile device 102 also includes an operating system 112. The operating system 112 manages hardware, software, and firmware resources in the mobile device 102. The operating system 112 manages one or more applications 114 running on the mobile device 102 and operates as an interface between applications 114 and hardware components of the mobile device 102.

The mobile device 102 also includes a communication system 116. The communication system 116 is operable to manage communication with various other devices. The mobile device 102 can be connected to one or more external devices and communicate with the external devices using any of a variety of wired or wireless connections, such as USB, USB-C, WiFi™, WiFi™ IP (Internet Protocol), USB IP, DisplayPort, High-Definition Multimedia Interface (HDMI), and so forth.

The mobile device 102 includes an illumination compensation system 118 that can be implemented in a variety of different manners. For example, the illumination compensation system 118 can be implemented as multiple instructions stored on computer-readable storage media and that can be executed by the processing system 110. Additionally or alternatively, the illumination compensation system 118 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth). The illumination compensation system 118 is depicted including a flicker sensor 120 and an illumination and feature detection module 122. The illumination compensation system 118 is in electronic communication with other components and systems of the mobile device 102 such as an image sensor 124, storage device 126, and so forth.

The storage device 126 can be implemented using any of a variety of storage technologies, such as magnetic disk, optical disc, Flash, or other solid state memory, and so forth. The storage device 126 can store various program instructions and data for any one or more of the operating system 112, application 114, and the illumination compensation system 118.

The mobile device 102 includes an image sensor 124 operable to acquire digital images of objects and other features within an environment of the mobile device 102. For example, the image sensor 124 may be part of a camera assembly including a lens and other components to support acquisition of digital images (e.g., digital photographs) using the image sensor 124. The image sensor 124 includes a plurality of photosensitive elements that receive light from the environment of the mobile device 102 and generate electronic signals indicating characteristics of the received light such as intensity, wavelength, and so forth. The electronic signals from the photosensitive elements are used by the mobile device 102 to assign values (e.g., color or grayscale values) to pixels in pixel data associated with the digital images.

The image sensor 124 can acquire image data in various modes. Such modes may include, for example, a preview image mode, a full-resolution image mode, and a panoramic image mode. In the preview image mode, the image sensor 124 acquires preview image data that may have a lower pixel resolution compared to image data acquired in the full-resolution image mode. The preview image data may be displayed by the display 104 of the mobile device 102 and may be deleted thereafter (e.g., removed from memory once the preview image data has been displayed). The preview image data may thus be utilized for electronic view-finding functionality to indicate the portion of the environment of the mobile device 102 that is imageable via the image sensor 124 based on the position and orientation of the mobile device 102 within the environment. For example, as the mobile device 102 is moved within the environment, the portion of the environment depicted by the preview image data updates accordingly. Thus, in the preview image mode, preview image frames may be displayed sequentially, automatically (e.g., without human interaction), and substantially in real-time.

The full-resolution image mode, in contrast with the preview image mode, may acquire image data in response to user input applied to the mobile device 102. Consider a scenario in which the image sensor 124 is operated in the preview image mode. A user may adjust the position and/or orientation of the mobile device 102 until the preview image data display at the display 104 depicts the desired portion of the environment to be imaged. Once the mobile device 102 has been positioned accordingly, user input to the mobile device 102 adjusts operation of the image sensor 124 from the preview image mode to the full resolution image mode or the panoramic image mode for acquisition of digital images to be stored to the storage device 126 and/or cloud storage (e.g., over a network). The user input may include, for example, pressing one or more physical buttons of the mobile device 102, applying touchscreen input to one or more graphical user interface elements displayed by the display 104, and so forth.

In some implementations, operation of the image sensor 124 in the panoramic image mode includes acquiring multiple full-resolution images of the environment which are aligned and joined to form digital images having a wider aspect ratio than images acquired in the full-resolution image mode. The image sensor 124 is in electronic communication with the illumination compensation system 118 and can provide image data (e.g., preview image frames, full-resolution image frames, etc.) to the illumination compensation system 118 to support the techniques for flicker compensation for mixed lighting conditions described herein.

The illumination compensation system 118 includes a flicker sensor 120. The flicker sensor 120 may be employed by the illumination compensation system 118 to detect and measure fluctuations in light intensity (e.g., light flickering) in an environment of the mobile device 102. Such fluctuations can arise from variations in electrical power provided to the light sources and/or the particular configurations of the light sources. Many light sources are configured to alternate (e.g., pulse) between outputting light and not outputting light, and the alternating often occurs at sufficiently high speeds such that the alternating is not perceptible to human vision. However, light intensity fluctuations can occur even when the alternating is not perceptible to human vision. The image sensor 124 can acquire digital images at speeds that are equal to or greater than the speeds at which light intensity fluctuations occur, which can result in abnormalities in digital images acquired by the image sensor 124.

The light detected by the flicker sensor 120 may originate from various different illumination sources within the environment of the mobile device 102. For example, the light emitted by multiple illumination sources may blend, and the blended light may be received by the flicker sensor 120. Thus, the flicker sensor 120 may detect an overall illumination intensity within the environment, and the detected fluctuations are associated with the overall illumination of the environment.

The flicker sensor 120 detects and measures such fluctuations and outputs electronic signals (e.g., data) based on the fluctuations. The signals output by the flicker sensor 120 are used by the illumination compensation system 118 to control operation of the image sensor 124 (e.g., adjust an image capture speed of the image sensor 124 based on the measured fluctuations). For example, the flicker sensor 120 may output signals indicating a frequency of the alternating of a light source as described above, and the illumination compensation system 118 can accordingly adjust a timing of image capture performed by the image sensor 124 to reduce a likelihood of image abnormalities.

In some situations, the fluctuations of light output by individual illumination sources may be out of phase relative to fluctuations of other illumination sources within the environment. For example, fluctuations of light output by individual illumination sources can contribute to fluctuations of the overall illumination of the environment. This can cause irregular and unpredictable fluctuations of the overall illumination of the environment. Such irregular and unpredictable fluctuations can cause the flicker sensor 120 to associate fluctuation frequencies with the overall illumination that are not consistent with the actual fluctuations of illumination intensity. For example, the irregular fluctuations can cause the flicker sensor 120 to determine various frequencies associated with the overall illumination that do not accurately represent the real irregular fluctuation of the overall illumination. However, the techniques for flicker compensation for mixed lighting conditions described herein address such issues as described further below.

The illumination compensation system 118 additionally includes an illumination and feature detection module 122. The illumination and feature detection module 122 is employed by the mobile device 102 to detect illumination sources within the environment of the mobile device 102 using image data from the image sensor 124. In some implementations, the illumination and feature detection module 122 is employed to detect objects, human faces, and/or other features within the environment. By detecting the illumination sources and/or other features, the illumination and feature detection module 122 supports the techniques for conditional flicker compensation for mixed lighting conditions described herein.

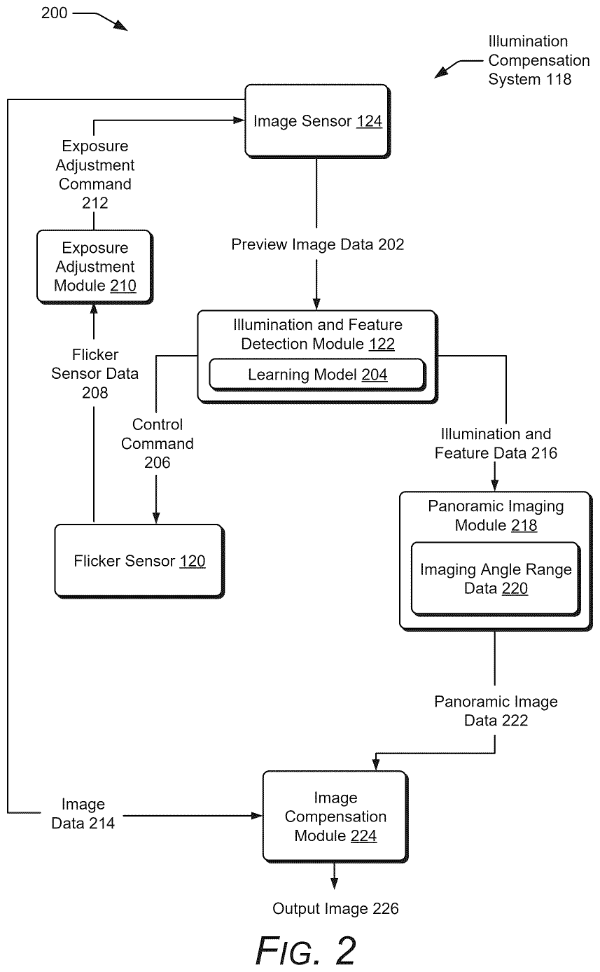

FIG. 2 illustrates an example 200 showing an implementation of the illumination compensation system 118 for mobile device conditional flicker compensation for mixed lighting conditions. In the depicted implementation, preview image data 202 is provided to an illumination and feature detection module 122.

The preview image data 202 may be displayed via the display 104 and may depict a substantially real-time view of a portion of an environment that will be imaged by the image sensor 124 (e.g., displaying a digital preview of the environment at the display 104 and updating the digital preview in real-time as the mobile device 102 is moved within the environment). For example, the image sensor 124 may generate the preview image data 202 based on light received by photosensitive elements of the image sensor 124, but the preview image data 202 may be at a lower pixel resolution (e.g., a non-interpolated resolution and/or a resolution associated with a subset of photosensitive elements) relative to images and/or video acquired and stored by the mobile device 102.

Further, once the preview image data 202 has been displayed, the preview image data 202 may be deleted from the mobile device 102. For example, the preview image data 202 may be generated and displayed at a rate of thirty preview image frames per second, sixty preview image frames per second, etc., and once a given preview image frame has been displayed by the display 104, that preview image frame may be discarded (e.g., removed from a memory of the mobile device 102). The preview image data 202 may thus be utilized for electronic view-finding to aid with positioning the mobile device 102 at a location and/or orientation within the environment for image acquisition.

Once the mobile device 102 has been positioned as desired by a user, the user may provide input to the mobile device 102 (e.g., input using a graphical user interface of the mobile device 102, one or more physical buttons of the mobile device 102, etc.) to initiate acquisition of one or more images at a higher resolution suitable for digital photography based on imaging settings of the mobile device 102 (e.g., adjust the mobile device 102 from operating the image sensor 124 in the preview image mode to operating in the full-resolution image mode). As one example, each preview image frame of the preview image data 202 may have a resolution corresponding to a pixel resolution of the display 104 (e.g., 1,360 pixels by 900 pixels) while images acquired by initiating image acquisition may have a higher resolution (e.g., twice the preview image frame resolution, four times the preview image resolution, ten times the preview image resolution, etc.).

The illumination and feature detection module 122 is configured to detect features depicted by the preview image data 202. For example, the illumination and feature detection module 122 can detect illumination sources and illumination emitted by the illumination sources within the preview image data 202. In some implementations, the illumination and feature detection module 122 can detect human faces and other objects within the environment. In implementations, the illumination and feature detection module 122 detects features depicted by the preview image data 202 using a learning model 204. The learning model 204 may include one or more machine-learning models trained to detect the illumination sources and other features.

As used herein, the term “machine-learning model” refers to a computer representation that is tunable (e.g., through training and retraining) based on inputs without being actively programmed by a user to approximate unknown functions, automatically and without user intervention. A machine-learning model may be a multi-modal model utilizing networks and algorithms to learn from, and make predictions on, known data by analyzing training data to learn and relearn to generate outputs that reflect patterns and attributes of the training data. For example, the learning model 204 may employ one or more machine-learning models configured as neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. for performing the techniques described herein. The learning model 204 may implement one or more large language models (LLMs) capable of interpreting natural language input by employing the networks and algorithms, such as one or more of the example networks and algorithms described above. The learning model 204 executes on one or more processors, such as one or more processors of the processing system 110 and/or processors implementing a cloud computing system accessible via a network using the communication system 116.

The illumination and feature detection module 122 is in electronic communication with the flicker sensor 120. Responsive to the detected environmental conditions, the illumination and feature detection module 122 is operable to adjust a control command 206 provided to the flicker sensor 120 to control operation of the flicker sensor 120. For example, during conditions in which the illumination and feature detection module 122 detects that mixed illumination is not present within the environment of the mobile device 102, the control command 206 is set by the illumination and feature detection module 122 to activate the flicker sensor 120 or maintain the flicker sensor 120 in the activated condition.

While the flicker sensor 120 is activated, the flicker sensor 120 receives illumination from the environment of the mobile device 102 and generates flicker sensor data 208 based on the received illumination. The flicker sensor data 208 includes information describing properties associated with the illumination. Such information can include, for example, a flicker frequency of the illumination (e.g., a rate at which the illumination fluctuates by flickering or pulsing), an amplitude of fluctuation of the illumination relative to an average illumination amount within the environment, one or more waveforms describing an intensity of the illumination over time, a duty cycle of the illumination, and so forth.

The flicker sensor data 208 is provided to an exposure adjustment module 210. The exposure adjustment module 210 processes the flicker sensor data 208 and determines an exposure adjustment to be communicated to the image sensor 124 as an exposure adjustment command 212. Operation of the image sensor 124 is adjusted by way of the exposure adjustment command 212. For example, the exposure adjustment command 212 can cause the exposure timing and/or exposure duration of the image sensor 124 to be increased, decreased, or maintained based on the illumination properties described by the flicker sensor data 208. Increasing or decreasing the exposure timing can include delaying or advancing, respectively, a timing associated with exposing the image sensor 124 to illumination within the environment (e.g., for generating digital images of the environment).

The exposure timing and/or exposure duration can be adjusted using the exposure adjustment command 212 during conditions in which the environment does not include mixed illumination. As a result, exposure of the image sensor 124 to illumination in the environment can be timed to reduce a likelihood of image abnormalities such as banding in image data 214 generated by the image sensor 124. However, if the illumination and feature detection module 122 detects that the environment includes mixed illumination, illumination and feature data 216 generated by the illumination and feature detection module 122 is provided to a panoramic imaging module 218.

The panoramic imaging module 218 processes the illumination and feature data 216 and generates imaging angle range data 220 based on the illumination and feature data 216. The panoramic imaging module 218 is employed by the illumination compensation system 118 to guide acquisition of panoramic image data 222 via the image sensor 124, and the imaging angle range data 220 specifies an angle range within which the panoramic image data 222 is acquired. The panoramic image data 222 includes a plurality of image frames acquired within the angle range specified by the imaging angle range data 220. As one example, each degree of the angle range specified by the imaging angle range data 220 may be associated with a respective image frame of the panoramic image data 222.

The panoramic imaging module 218 generates the panoramic image data 222 using the image sensor 124 and provides the panoramic image data 222 to an image compensation module 224. The image compensation module 224 processes the panoramic image data 222 and generates an output image 226 from the panoramic image data 222 in accordance with the techniques described herein.

In some implementations, the output image 226 is generated using a single image frame of the panoramic image data 222 that does not depict mixed illumination. For example, although the illumination and feature detection module 122 can detect that the environment includes mixed illumination based on the preview image data 202, one or more individual frames within the panoramic image data 222 may depict a portion of the environment that does not include the mixed illumination. The output image 226 can be generated via the image compensation module 224 from at least one of the image frames of the panoramic image data 222 that does not depict mixed illumination.

In some implementations, the output image 226 is generated using multiple image frames of the panoramic image data 222 that are composited by the image compensation module 224 to form the output image 226. For example, image frames of the panoramic image data 222 may be composited by the image compensation module 224 to form the output image 226 without banding or other image abnormalities that may be present in the image frames of the panoramic image data 222. As one example, image frames of the panoramic image data 222 that include banding toward one side can be composited with image frames that include banding toward an opposite side, with the banding of the image frames of the panoramic image data 222 eliminated from the resulting output image 226 generated by the image compensation module 224.

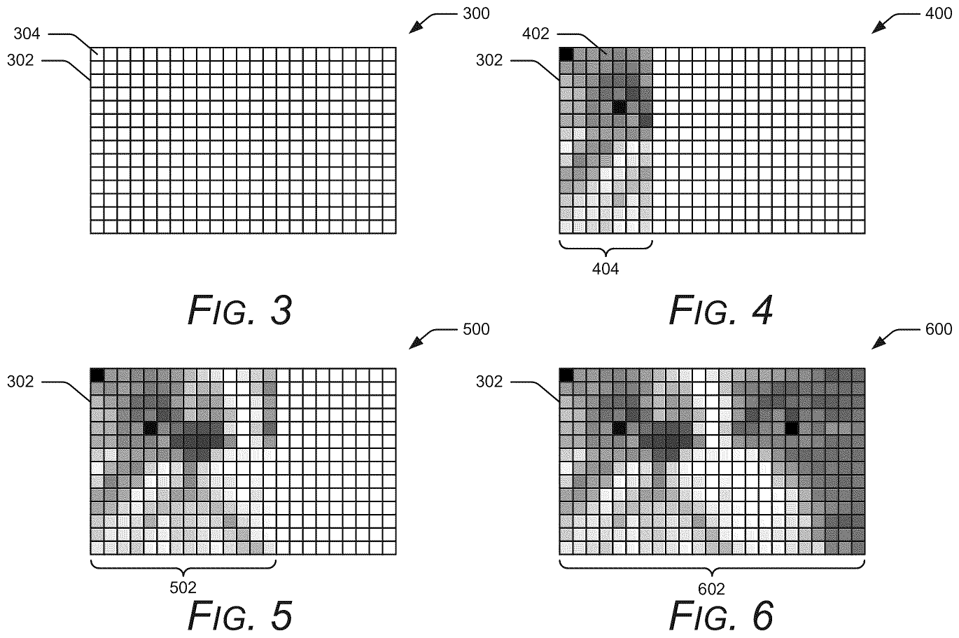

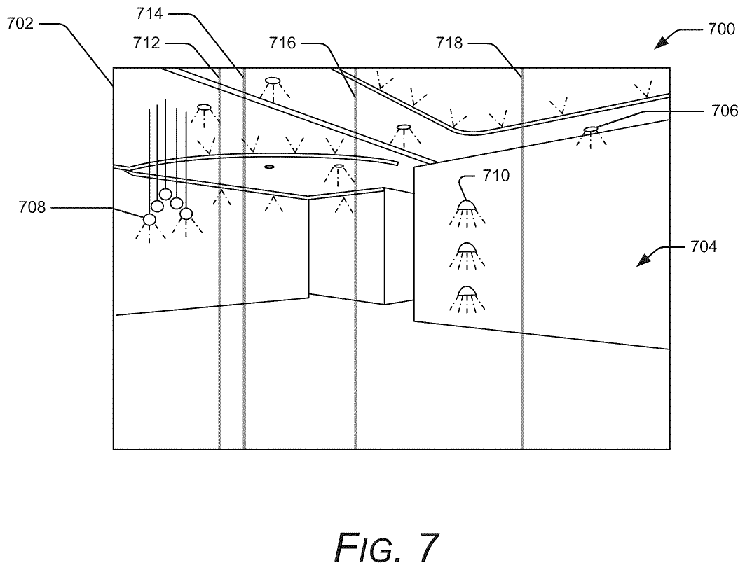

FIGS. 3-6 illustrate example stages of image acquisition using an image sensor as discussed herein. In particular, FIG. 3 illustrates an example 300 of a first stage in a sequence of an image acquisition process, FIG. 4 illustrates an example 400 of a second stage in the sequence of the image acquisition process, FIG. 5 illustrates an example 500 of a third stage in the sequence of the image acquisition process, and FIG. 6 illustrates an example 600 of a fourth stage in the sequence of the image acquisition process. The image acquisition process employs the image sensor 124 described above for capturing a digital image.

In the examples depicted by FIGS. 3-6, a grid 302 is shown. Each individual unit (e.g., square) of the grid 302 represents pixel data acquired via the image sensor 124 (e.g., each square represents an individual pixel of the pixel data, such as unit 304). In some configurations, a color value of each pixel is determined via a respective photosensitive element of the image sensor 124 associated with the pixel. For example, photosensitive elements of the image sensor 124 may be arranged in a grid pattern similar to the grid 302, with each photosensitive element configured to detect light and determine a color of a corresponding pixel of the pixel data. The pixels, once assigned colors based on the detection of light by the photosensitive elements, form an image of a subject imaged by the image sensor 124. It should be appreciated the pixel data may include a different number of pixels than those depicted by the grid 302 of the examples shown by FIGS. 3-6.

In the example 300, the photosensitive elements of the image sensor 124 have not been activated to detect light and thus have not determined colors associated with pixels included by the pixel data. As a result, the grid 302 is depicted without fills (e.g., each unit of the grid 302 is without coloration).

In the example 400, the second stage in the sequence of image acquisition using the image sensor 124 is depicted. The grid 302 is depicted with some of the units filled in the example 400 (e.g., a subset of the units of the grid 302 are depicted with coloration). The partially filled grid 302 indicates that acquisition of pixel data (which may be referred to herein as image data) has been initiated. The second stage shown by example 400 may immediately follow the first stage shown by example 300, for instance. Upon initiation of the acquisition of pixel data, the photosensitive elements are activated beginning from the left side of the grid 302. Activation of the photosensitive elements refers to active detection of light, measurement of light intensity, light wavelength, and so forth via the photosensitive elements. The second stage depicted by FIG. 4 is a transitionary stage that occurs during acquisition of pixel data as represented by the units of the grid 302. The example 400 thus depicts a set of pixels, such as pixel 402, that have been assigned color values based on light received by the respective photosensitive elements of the image sensor 124. In the example 400, although a portion 404 of the pixels have been assigned color values, other pixels have not.

Example 500 depicts the third stage in the sequence of image acquisition using the image sensor 124. In the example 500, acquisition of pixel data has continued from the second stage depicted by FIG. 4. The third stage depicted by the example 500 is another transitionary stage that occurs during acquisition of pixel data as represented by the units of the grid 302. In the example 500, a portion 502 of the pixels have been assigned color values, while other pixels have not. The portion 502 includes more pixels than the portion 404 described above. The third stage is thus a progression of the image acquisition from the second stage, and additional pixels have been assigned color values in the third stage relative to pixels assigned color values in the second stage.

Example 600 depicts the fourth stage in the sequence of image acquisition using the image sensor 124. In the example 600, acquisition of pixel data has continued from the third stage depicted by FIG. 5 and has completed with a full amount 602 of the depicted pixels having an assigned color value. The pixels in the example 600 collectively form an image of a subject imaged by the image sensor 124.

During the image acquisition process progressing from the first stage to the second stage, from the second stage to the third stage, and from the third stage to the fourth stage as described above, pixels are sequentially assigned values until the image of the subject is completed. The process may include a plurality of intermediate stages not shown by the figures, such as one or more stages between the second stage and the third stage in which a portion of pixels assigned color values is larger than the portion 404 and smaller than the portion 502.

An amount of time spanning from initiation of the image acquisition at the first stage and completion of the image acquisition at the fourth stage may be based on an exposure setting associated with the image. For example, progression of the image acquisition process for images associated with smaller exposure settings may occur within a smaller amount of time (e.g., such that a smaller amount of light is received at the photosensitive elements). Progression of the image acquisition process for images associated with larger exposure settings may occur within a larger amount of time (e.g., such that a larger amount of light is received at the photosensitive elements).

FIG. 7 illustrates an example 700 of an image 702 acquired using an image sensor of a mobile device in an environment 704 with mixed lighting conditions. The image sensor may be the image sensor 124 of the mobile device 102 described above. The depicted environment 704 is one example environment of the mobile device 102. The mixed lighting conditions of the environment 704 in which the image 702 is acquired result from mixed illumination sources within the environment 704 (e.g., illumination sources operating at different output frequencies). Some of the illumination sources are depicted in the image 702, such as illumination source 706, illumination source 708, illumination source 710, etc. One or more of the illumination sources may be a light-emitting diode (LED) illumination source.

The image 702 depicts artifacts (e.g., undesired imaging abnormalities) that can occur during conditions in which conventional imaging techniques are performed in an environment that includes mixed illumination sources (e.g., environment 704). The artifacts within the image 702 include banding such as a first band 712, a second band 714, a third band 716, and a fourth band 718. The bands are caused by abnormal light exposure of photosensitive elements of the image sensor. The abnormal light exposure results from abnormal operation of a flicker sensor, such as the flicker sensor 120, in the presence of the mixed illumination sources.

As an example, some illumination sources of the mixed illumination sources may operate with output frequencies within a first range of frequencies and other illumination sources of the mixed illumination sources may operate with output frequencies within a second range of frequencies. The exposure of the image sensor may be adjusted based on an output of the flicker sensor to account for the illumination sources having output frequencies in the first range. However, the artifacts in the image 702 may appear due to frequencies in the second range of frequencies being out of phase with frequencies in the first range of frequencies.

The techniques described herein address such issues by adjusting operation of the flicker sensor 120 based on detection of mixed illumination sources within the environment. By implementing the described techniques, images may be generated in environments with mixed illumination sources without artifacts such as the banding represented by the first band 712, the second band 714, etc.

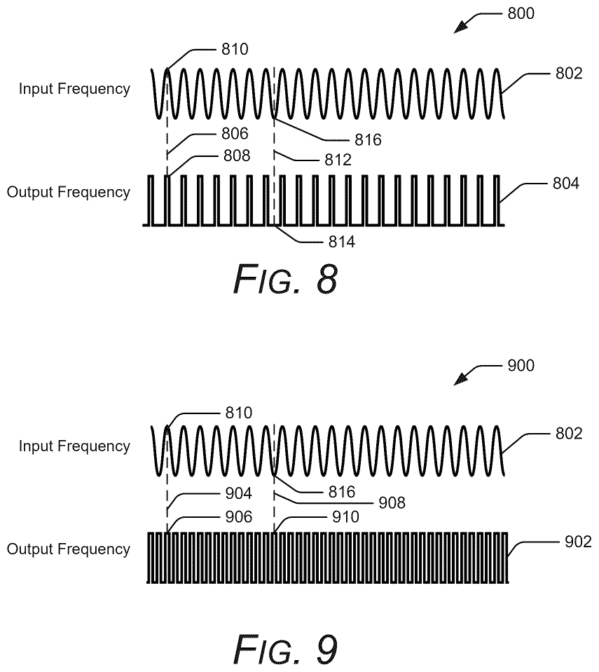

FIGS. 8-9 illustrate example input frequencies and output frequencies associated with light sources. Example 800 depicts a first plot 802 showing an example input frequency for an illumination source and a second plot 804 showing an example output frequency of the illumination source. In this example, the illumination source is an LED illumination source. The input frequency refers to an electrical frequency associated with a power source, such as utility electrical power (e.g., electrical power delivered to a building via infrastructure and provided at a wall outlet). In some examples, the input frequency is sixty hertz.

The output frequency refers to a frequency of illumination of the illumination source responsive to providing the illumination source with electrical power having the input frequency depicted by the first plot 802. In the example, the peaks of the second plot 804 indicate moments during which the illumination source emits light, and the troughs of the second plot 804 indicate moments during which the illumination source does not emit light.

An axis 806 is depicted aligned with peak 808 of the second plot 804 and peak 810 of the first plot 802. Additionally, an axis 812 is depicted aligned with a trough 814 of the second plot 804 and a trough 816 of the first plot 802. In the depicted configuration, the output frequency is in phase with the input frequency. However, the LED illumination source may have different output frequencies that may not be in phase with the input frequency. Further, different LED illumination sources may have different output frequencies relative to each other within a wide range of frequencies (e.g., between fifty hertz and three-hundred hertz).

The output frequency of the illumination source is sufficiently high such that the moments during which the illumination source does not emit light, as indicated by the troughs, are imperceptible to human vision. Thus, when viewed by an individual, the light emitted by the illumination source appears to be constant.

However, as described above with reference to FIGS. 3-6, the image sensor 124 acquires image data by determining pixel color values according to light that is received by photosensitive elements of the image sensor 124. The color values may include, for example, a red value, a blue value, and a green value for each pixel. During conditions in which acquisition of an image has been initiated, the image sensor 124 may assign color values to the pixels sequentially, e.g., transitioning from the first stage shown by FIG. 3 to the second stage shown by FIG. 4, transitioning from the second stage to the third stage shown by FIG. 5, and transitioning from the third stage to the fourth stage shown by FIG. 6).

During the image acquisition process, moments may occur in which a timing of the exposure of the photosensitive elements to the light overlaps with a timing of the troughs of the output frequency of the illumination source. As a result, some photosensitive elements of the image sensor may be underexposed relative to other photosensitive elements of the image sensor. The underexposure of some of the elements can lead to artifacts such as the banding described above with reference to FIG. 7.

Further, although the flicker sensor 120 may be employed to detect the output frequency of an illumination source so that the exposure of the image sensor can be timed accordingly to avoid artifacts such as banding, it can be difficult or impossible for the flicker sensor 120 to do so in conditions in which multiple illumination sources are present that have different output frequencies. For example, in environments that include multiple different LED illumination sources (e.g., mixed illumination), adjusting the exposure timing in view of the output frequency of a first illumination source may cause undesired underexposure of photosensitive elements of the image sensor from one or more other illumination sources (e.g., sources having different output frequencies relative to the first illumination source). However, the techniques described herein are implemented to address such issues, as described further below.

Example 900 depicts the first plot 802 showing the example input frequency for another illumination source and a third plot 902 showing an example output frequency of the illumination source. In this example, the illumination source is an LED illumination source. However, in this example, the output frequency of the illumination source is higher than the output frequency described above with reference to FIG. 8.

In the example, an axis 904 is depicted aligned with the peak 810 of the first plot 802 and a peak 906 of the third plot 902. Additionally, an axis 908 is depicted aligned with the trough 816 of the first plot 802 and another peak 910 of the third plot 902.

Although the example 800 and the example 900 each depict the same input frequency represented by the first plot 802, the output frequencies of the illumination sources are different. For example, the output frequency represented by the second plot 804 associated with one LED illumination source is different than the output frequency represented by the third plot 902 associated with another LED illumination source.

Within an example environment, such as the environment 704 depicted by FIG. 7 and described above, the illumination source described by the example 800 and the illumination source described by the example 900 may each be present (e.g., emitting light to illuminate the environment 704). For example, the illumination source described in the example 800 may be the illumination source 706, and the illumination source described in the example 900 may be the illumination source 708. Challenges associated with imaging such environments are addressed by the techniques described herein.

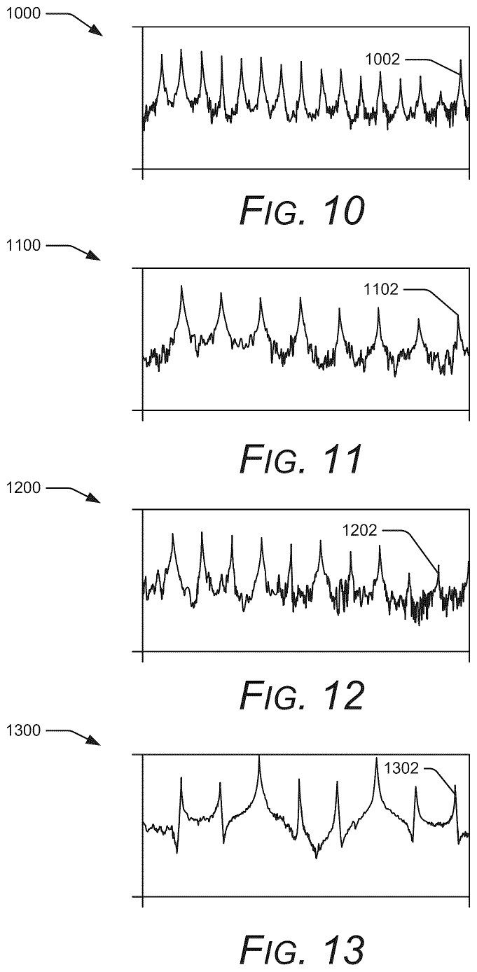

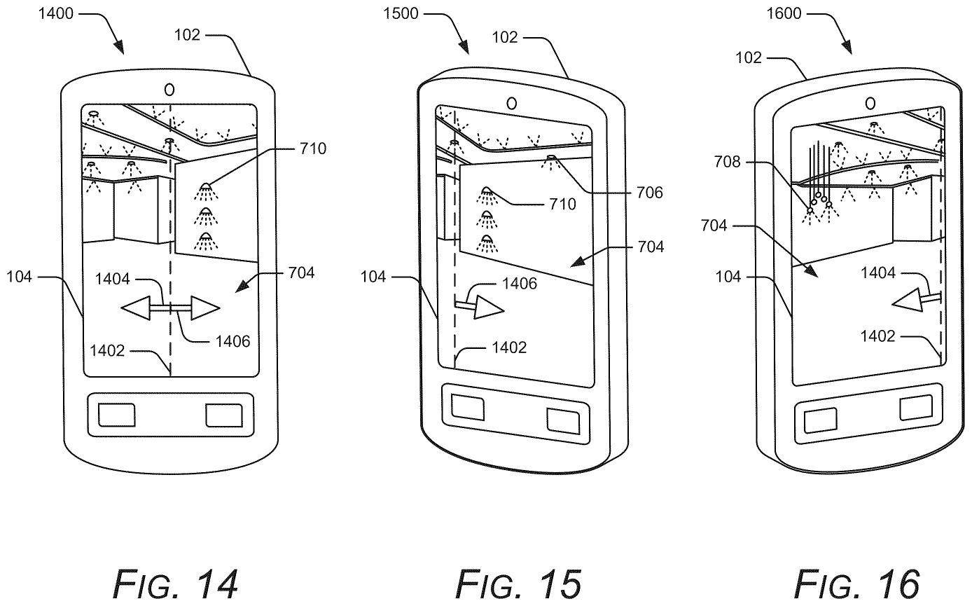

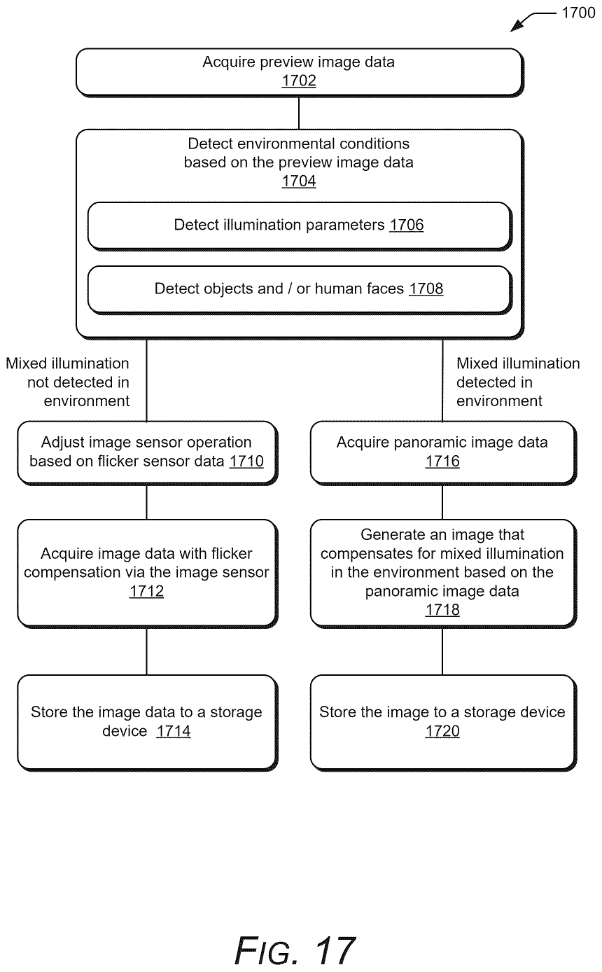

FIGS. 10-13 illustrate example output frequencies of different light sources. In particular, an example 1000 shown by FIG. 10 depicts a graph including a plot 1002. The plot 1002 represents an output frequency of a first illumination source within an environment, such as the environment 704. An example 1100 shown by FIG. 11 depicts a graph including a plot 1102 representing another output frequency of another illumination source within an environment such as the environment 704. An example 1200 shown by FIG. 12 depicts a graph including a plot 1202 representing another output frequency of another illumination source within an environment such as the environment 704. An example 1300 shown by FIG. 13 depicts a graph including a plot 1302 representing another output frequency of another illumination source within an environment such as the environment 704.

The illumination sources having outputs represented in example 1000, example 1100, example 1200, and example 1300 may each be included within the same environment (e.g., within environment 704). During such conditions, the various output frequencies may be out of phase relative to each other, which may lead to difficulty of adjustment of the exposure timing of the image sensor 124 to prevent occurrence of artifacts in the generated image. However, as described above with reference to examples 800 and 900, the techniques described herein address such technical challenges. One way such technical challenges may be addressed is illustrated by FIGS. 14-16 and described below.

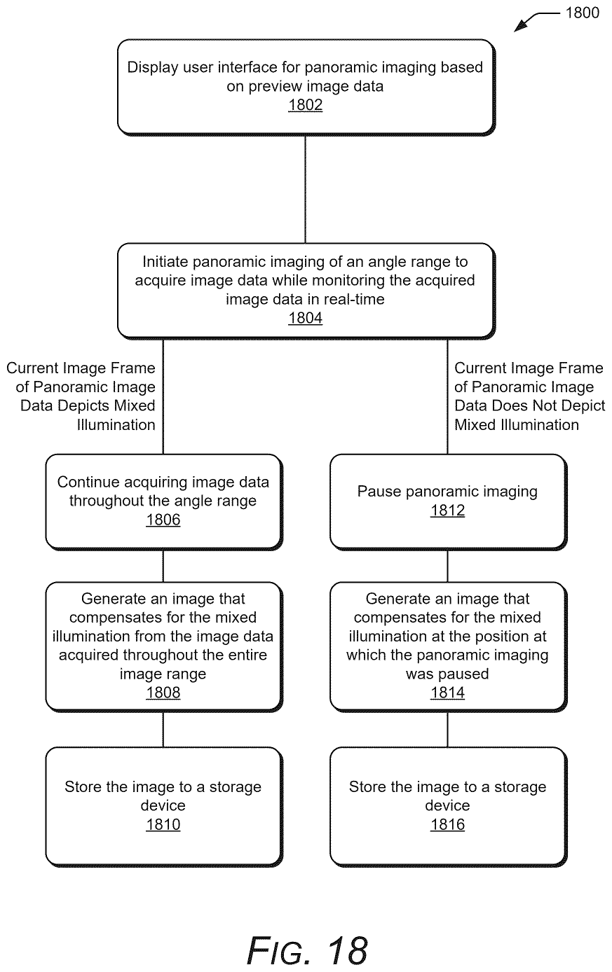

FIGS. 14-16 illustrate different stages of imaging an environment with mixed lighting conditions in accordance with the described techniques. FIG. 14 depicts an example 1400 showing a first stage in a process for imaging in an environment including mixed illumination. In particular, the environment 704 is depicted. The environment 704 is one non-limiting example of an environment that may be imaged according to the techniques described herein. However, other environments may be imaged via the described techniques. FIG. 15 depicts an example 1500 showing a second stage in the process for imaging in the environment 704. FIG. 16 depicts an example 1600 showing a third stage in the process for imaging in the environment 704.

Although the example 1400 is described as depicting the first stage in the process, the example 1500 is described as depicting the second stage in the process, and the example 1600 is described as depicting the third stage in the process, it should be appreciated that the first stage, the second stage, and the third stage may occur in different orders. For example, the second stage depicted by example 1500 may occur prior to each of the first stage depicted by example 1400 and the third stage depicted by example 1600. Other orders are possible.

In the example 1400, the mobile device 102 is depicted at a first position (e.g., a first orientation relative to the environment 704) such that the display 104 depicts a portion of the environment 704 to be imaged. In the example 1400, imaging of the environment 704 has been initiated. The initiation of the imaging of the environment 704 may include, for example, receiving user input indicating a request to acquire one or more full-resolution images using the image sensor 124. Full-resolution images refer to digital images having a pixel resolution that may be configured via settings stored in a memory of the mobile device 102 (e.g., images acquired while operating in the full-resolution image mode).

While performing the image acquisition in situations in which mixed illumination is detected within the environment to be imaged, the illumination compensation system 118 may display one or more graphic user interface elements at the display 104 to guide the user to move the mobile device 102 and acquire panoramic image data. In the examples shown by FIGS. 14-16, the illumination compensation system 118 displays an axis 1402, an arrow 1404, and an arrow 1406 overlaying preview image data of the environment 704.

In an example operation, the mobile device 102 is oriented by the user toward a portion of the environment 704 to be imaged. In this example, the portion is depicted by FIG. 14. Responsive to receiving user input indicating a request to acquire one or more images of the portion of the environment 704 shown as preview image data at the display 104, the illumination compensation system 118 displays the axis 1402 centered at the display 104 and overlapping the preview image data. The arrow 1404 and the arrow 1406 are employed to guide the movement of the mobile device 102 within the environment 704.

Continuing the example operation, the illumination compensation system 118 guides the user to move the mobile device 102 from the orientation shown by FIG. 14 to the orientation shown by FIG. 15. In the orientation shown by FIG. 14, the illumination source 710 is within an imaging field of view of the image sensor 124 and is depicted in the preview image data. Following adjustment of the orientation of the mobile device 102 to the orientation shown by FIG. 15, the illumination source 706 is additionally within the imaging field of view of the image sensor 124 and is depicted in the preview image data. Further, following adjustment of the orientation of the mobile device 102 to the orientation shown by FIG. 16, the illumination source 708 is within the imaging field of view of the image sensor 124. However, in this orientation, the illumination source 710 and the illumination source 706 are not within the field of view of the image sensor 124 and are not depicted by the preview image data.

The illumination compensation system 118 employs the image sensor 124 to acquire panoramic image data throughout the adjustment of the mobile device 102 to the different orientations described above. The panoramic image data can include multiple image frames acquired within an angle range (e.g., a range of rotation of the mobile device 102 within the environment). In some implementations, the image frames may be full-resolution image frames with a pixel resolution corresponding to the pixel resolution of image frames acquired in the full-resolution image mode. In some implementations, one or more image frames included by the panoramic image data may be discarded (e.g., removed from memory) once the panoramic image data has been processed and an image adjusted for multiple illumination sources has been generated as described herein.

By processing the panoramic image data, the illumination compensation system 118 identifies the various illumination sources and determines the location of the illumination sources within the environment 704. Using this information, the illumination compensation system 118 is able to guide the user to adjust image acquisition (e.g., adjust exposure timing) based on the number, location, and/or output frequency of the illumination sources to compensate for the mixed illumination. In some implementations, the illumination compensation system 118 may guide the user to orient the mobile device 102 such that a single illumination source is more prominent in the field of view of the image sensor 124 than other illumination sources. For example, an illumination source may be less prominent while the illumination source is located toward edges of the field of view, and the same illumination source may be more prominent while the illumination source is located toward a center of the field of view. As another example, an illumination source may be more prominent than other illumination sources when an intensity of light emitted in the field of view by the illumination source is greater than intensities of the other illumination sources (e.g., the image sensor 124 receives a larger amount of light from the illumination source than the other illumination sources).

By guiding the user to orient the mobile device 102 to emphasize the single illumination source in the image acquisition, the illumination compensation system 118 can reduce or eliminate artifacts in the image that would result from the mixed illumination (e.g., illumination from multiple LED illumination sources operating with output frequencies that are out of phase relative to each other).

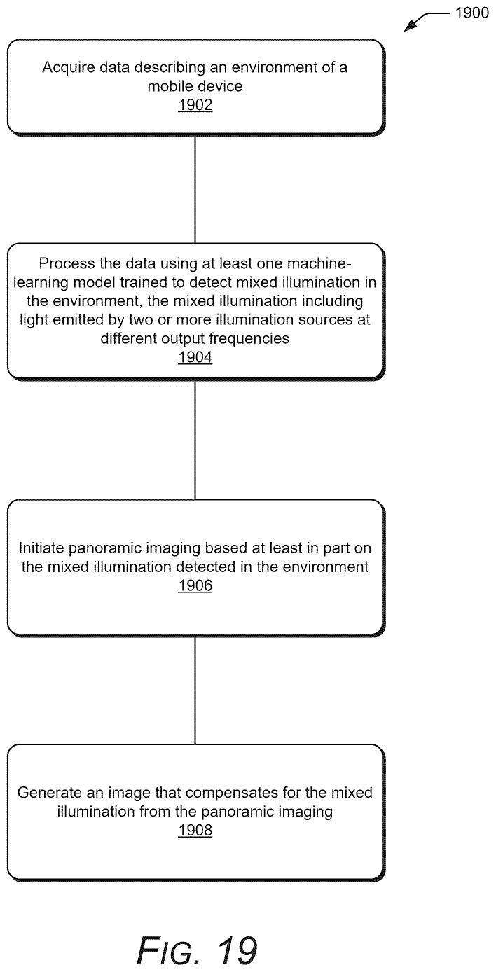

FIG. 17 illustrates an example process 1700 for implementing the techniques discussed herein in accordance with one or more embodiments. Process 1700 is carried out by an illumination compensation system, such as the illumination compensation system 118 of FIG. 1, and can be implemented in software, firmware, hardware, or combinations thereof. Process 1700 is shown as a set of acts and is not limited to the order shown for performing the operations of the various acts.

In process 1700, image preview data is acquired (act 1702). By way of example, the mobile device 102 employs the image sensor 124 to generate preview image data 202.

Environmental conditions are detected based on the preview image data (act 1704). By way of example, detecting the environmental conditions includes processing the preview image data 202 using the illumination and feature detection module 122. In implementations, detecting the environmental conditions includes detecting illumination parameters (act 1706) and/or detecting objects and/or human faces (act 1708). For example, the illumination and feature detection module 122 may employ one or more object detection algorithms to detect the objects and/or human faces. The illumination and feature detection module 122 may further employ one or more illumination detection algorithms to detect illumination sources based on information from the preview image data 202 such as clustering of similar pixel color intensities, pixel color intensity gradients, and/or other information.

In some implementations, the illumination and feature detection module 122 employs one or more machine-learning models of the learning model 204 to detect the illumination sources, the objects, and/or the human faces. For example, the learning model 204 may include a machine-learning model trained on data describing various illumination sources (e.g., output frequencies, colors, and/or intensities associated with such sources), a machine-learning model trained on facial feature data, and/or a machine-learning model trained to detect edges and other features of objects within an environment to identify the objects.

The illumination and feature detection module 122 may identify each illumination source illuminating the environment depicted by the preview image data 202. Based on the identified illumination sources, the illumination and feature detection module 122 may further determine whether the light emission from the illumination sources results in mixed illumination within the environment. Mixed illumination refers to multiple illumination sources operating with different output frequencies.

Process 1700 proceeds based on whether mixed illumination is detected in the environment. If mixed illumination is not detected, image sensor operation is adjusted based on the flicker sensor data (act 1710). The lack of mixed illumination indicates that a single illumination source is present, or each illumination source within the environment of the mobile device 102 has a same output frequency (e.g., multiple illumination sources that are in-phase relative to each other). By way of example, an exposure timing of the image sensor 124 is adjusted based on the detected output frequency of the one or more illumination sources (e.g., illumination sources that are in-phase with each other). For example, flicker sensor data 208 is generated by the flicker sensor 120 and provided to the exposure adjustment module 210. The exposure adjustment module 210 generates the exposure adjustment command 212 based on the flicker sensor data 208. The exposure adjustment command 212 is provided to the image sensor 124 and adjusts the exposure of the image sensor 124 accordingly (e.g., lengthening or shortening exposure duration, adjusting a timing of the exposure, etc.).

Image data is acquired with flicker compensation via the image sensor (act 1712). By way of example, the image sensor 124 is operated with the adjusted exposure timing to generate the image data 214 (e.g., one or more digital images). By adjusting the exposure timing based on the output frequency of the one or more illumination sources, a likelihood of artifacts appearing within the image data may be reduced or eliminated. For example, as described above with reference to FIG. 7, the exposure timing may be adjusted such that photosensitive elements of the image sensor 124 are not underexposed due to overlapping of the duration of the exposure with durations in which the one or more illumination sources do not emit light.

Specifically, the timing of the exposure of the image sensor 124 to acquire the image data 214 may be adjusted such that the entire duration of the exposure does not occur while the output frequency of the one or more illumination sources is low (e.g., as indicated at trough 814 shown by FIG. 8 and described above). In an example scenario in which the output frequency of the one or more illumination sources is sixty hertz and an exposure duration of the image sensor 124 is four-thousandths of a second, the timing of the exposure is adjusted such that the exposure occurs during a positive alternation of the output frequency of the one or more illumination sources (e.g., a duration through which light is actively emitted by the one or more illumination sources).

The image data is stored to a storage device (act 1714). By way of example, the image data 214 is provided to the image compensation module 224. As a result of determining that the environment does not include mixed illumination and that the image data 214 was acquired with the flicker sensor 120 activated, the image compensation module 224 generates output image 226 from the image data 214 without adjusting the image data 214 for mixed illumination. The output image 226 is stored to the storage device 126 (e.g., output to the storage device 126). In some examples, the image data may be stored to cloud storage (e.g., to a computing device over a network). In some implementations, the output image 226 is output to a display (e.g., display 104).

If mixed illumination is detected in the environment at act 1704, panoramic image data is acquired (act 1716). By way of example, the panoramic imaging module 218 guides adjustment of the orientation and/or location of the mobile device 102 to acquire the panoramic image data 222 as described above with reference to FIGS. 14-16. In situations in which one or more human faces are detected in the environment, the panoramic imaging module 218 may guide adjustment of the orientation and/or location of the mobile device 102 to image the one or more human faces via the panoramic image data 222.

An image that compensates for mixed illumination in the environment is generated based on the panoramic image data (act 1718). By way of example, the panoramic image data 222 is provided to the image compensation module 224. The image compensation module 224 processes the panoramic image data 222 and performs acts supporting the generation of the output image 226 that compensates for the mixed illumination within the environment. The acts may include, for example, the acts described further below with reference to process 1800 illustrated by FIG. 18. In some instances, the output image 226 is generated as a composite image based on multiple image frames included by the panoramic image data 222. In some instances, the output image 226 is generated from a single image frame included by the panoramic image data 222.

The image is stored to a storage device (act 1720). By way of example, the output image 226 is stored to the storage device 126 and/or cloud storage (e.g., output to the storage device 126 and/or cloud storage). In some implementations, the output image 226 is output to a display (e.g., the output image 226 is displayed by display 104).

FIG. 18 illustrates another example process 1800 for implementing the techniques discussed herein in accordance with one or more embodiments. Process 1800 is carried out by an illumination compensation system, such as the illumination compensation system 118 of FIG. 1, and can be implemented in software, firmware, hardware, or combinations thereof. Process 1800 is shown as a set of acts and is not limited to the order shown for performing the operations of the various acts. In some implementations, at least a portion of the process 1800 is performed as part of the process 1700 as described above.

In process 1800, a user interface is displayed for panoramic imaging based on preview image data (act 1802). By way of example, the user interface is a graphical user interface displayed by the display 104 and employed by the panoramic imaging module 218 to guide a user to acquire (e.g., generate) panoramic image data 222. The graphical user interface may include elements such as arrow 1404, arrow 1406, axis 1402, and/or other elements.

The panoramic imaging module 218 specifies an angle range for acquiring the panoramic image data 222 (e.g., via the imaging angle range data 220 described above). The angle range may be, for example, ninety degrees centered on a location depicted by the preview image data 202 (e.g., forty-five degrees to the left of the location and forty-five degrees to the right of the location), sixty degrees centered on the location, etc. The angle range refers to an amount of rotation of the mobile device 102 that occurs to acquire the panoramic image data 222 (e.g., rotation around a vertical axis centered on the mobile device 102, where the vertical axis is parallel to a direction of gravity). In some implementations, one or more indicators specifying the angle range (e.g., bounds of the angle range) may be displayed by the display 104.

Panoramic imaging of the angle range is initiated to acquire image data while monitoring the acquired image data in real-time (act 1804). By way of example, the angle range is determined by the panoramic imaging module 218 based on the preview image data 202 as described above and is specified by the imaging angle range data 220. For example, the angle range may be determined by the panoramic imaging module 218 based on the illumination and feature data 216 and a current position and/or orientation of the mobile device 102. In some implementations, the angle range may be centered to an illumination source depicted by the preview image data 202.

The panoramic image data 222 is monitored substantially in real-time. Specifically, as image frames are acquired while the acquisition of the panoramic image data 222 is performed, the illumination compensation system 118 monitors each of the image frames and can determine whether particular features are depicted in the image frames as described below.

Process 1800 proceeds based on whether the current image frame of the panoramic image data depicts mixed illumination. If the current image frame depicts mixed illumination, the panoramic imaging continues to acquire image data throughout the angle range (act 1806). By way of example, the panoramic image data 222 is acquired throughout the angle range specified by the imaging angle range data 220. The panoramic image data 222 may include image frames acquired continuously (or at particular intervals) as the mobile device 102 is rotated to orient the image sensor 124 throughout the entire angle range. The current image frame refers to the most recently acquired image frame of the panoramic image data 222.

An image that compensates for the mixed illumination is generated from the image data acquired throughout the entire image range (act 1808). By way of example, the image compensation module 224 may generate the output image 226 from the panoramic image data 222 by compositing (e.g., blending) individual frames included by the panoramic image data 222. The output image 226 may be composited responsive to acquiring the panoramic image data throughout an entirety of the angle range and detecting that each image frame of the panoramic image data depicts the environment illuminated by illumination sources having different output frequencies (e.g., mixed illumination). In implementations, the image frames included by the panoramic image data 222 have a same pixel resolution as the pixel resolution associated with the full-resolution image mode. In other implementations, the panoramic image data 222 includes image frames acquired at a lower pixel resolution than the pixel resolution of the output image 226, as well as some image frames acquired at the same pixel resolution as the pixel resolution associated with the full-resolution image mode.

The image compensation module 224 may generate the output image 226 by blending together two or more of the image frames of the panoramic image data 222 that have the same resolution as the pixel resolution setting associated with the output image 226. The image compensation module 224 may further select which image frames to blend based on the lower-resolution image frames included by the panoramic image data 222. For example, a number of the lower-resolution image frames acquired may be larger than a number of the higher-resolution image frames acquired. If a series of the lower-resolution image frames includes less artifacts (e.g., banding) compared to others of the lower-resolution image frames, the image compensation module 224 may determine that higher-resolution image frames having similar attributes compared to the series of lower-resolution image frames (e.g., acquired while the mobile device 102 is in a similar orientation) may be less likely to include such artifacts. The image compensation module 224 may thus select the higher-resolution image frames to be blended based on the lower-resolution image frame data.

The image is stored to a storage device (act 1810). By way of example, the output image 226 is stored to the storage device 126 and/or cloud storage (e.g., output to the storage device 126 and/or cloud storage). In some implementations, the output image 226 is output to a display (e.g., the output image 226 is displayed by display 104).

If the current image frame of the panoramic image data does not depict mixed illumination, the panoramic imaging is paused (act 1812). By way of example, during acquisition of the panoramic image data 222, the illumination compensation system 118 monitors each of the image frames acquired as described above. For example, the image compensation module 224 may be employed to continuously receive the panoramic image data 222 in real-time and monitor the image frames included by the panoramic image data 222 as the image frames are acquired. If the illumination compensation system 118 determines that the most recently acquired image frame does not depict mixed illumination, the acquisition of the panoramic image data 222 is paused. Pausing the panoramic imaging includes, for example, stopping acquisition of the panoramic image data 222 and displaying an indication (e.g., a visual alert) at the display 104 that the panoramic imaging has been stopped.

Additionally, responsive to determining that the most recently acquired image frame of the panoramic image data 222 does not depict mixed illumination, an indication for the user to maintain the position and/or orientation of the mobile device 102 may be displayed at the display 104. The maintained position and/or orientation corresponds to the position and/or orientation of the mobile device 102 at the time of acquisition of the most recently acquired image frame of the panoramic image data 222. By maintaining the position and/or orientation, a likelihood that another image acquired at the same position and/or orientation depicts mixed illumination is reduced.

An image that compensates for the mixed illumination is generated at the position at which the panoramic imaging was paused (act 1814). By way of example, the output image 226 is generated with the mobile device 102 at the position at which the panoramic imaging was paused, and the output image 226 does not depict the mixed illumination. In some implementations, the output image 226 is generated from the most recently acquired image frame of the panoramic image data 222. In some implementations, the image sensor 124 is employed to acquire image data 214 separately from the panoramic image data 222 at the position and/or orientation at which the panoramic imaging was paused, e.g., in the full-resolution image mode, and the output image 226 is generated from the image data 214.

The image is stored to a storage device (act 1816). By way of example, the output image 226 is stored to the storage device 126 and/or cloud storage (e.g., output to the storage device 126 and/or cloud storage). In some implementations, the output image 226 is output to a display (e.g., the output image 226 is displayed by display 104).

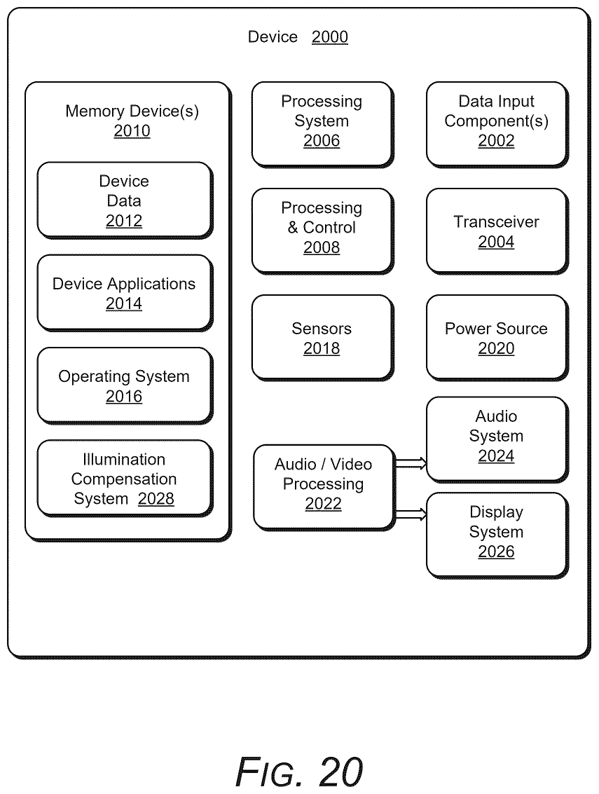

FIG. 19 illustrates another example process 1900 for implementing the techniques discussed herein in accordance with one or more embodiments. Process 1900 is carried out by an illumination compensation system, such as the illumination compensation system 118 of FIG. 1, and can be implemented in software, firmware, hardware, or combinations thereof. Process 1900 is shown as a set of acts and is not limited to the order shown for performing the operations of the various acts. In some implementations, at least a portion of the process 1900 is performed as part of the process 1700 and/or the process 1800 as described above.

In process 1900, data describing an environment of a mobile device is acquired (act 1902). By way of example, the mobile device 102 employs the image sensor 124 to generate preview image data 202. The preview image data 202 depicts the environment 704, for instance.

The data is processed using at least one machine-learning model trained to detect mixed illumination in the environment, the mixed illumination including light emitted by two or more illumination sources at different output frequencies (act 1904). By way of example, the preview image data 202 is processed using the learning model 204 of the illumination and feature detection module 122. One or more machine-learning models of the learning model 204 identify illumination sources illuminating the environment as depicted by the preview image data 202. The learning model 204 further determines an output frequency associated with each identified illumination source using the one or more machine-learning models. In some instances, the learning model 204 determines the output frequencies based at least in part on an output of the flicker sensor 120.

Panoramic imaging is initiated based at least in part on the mixed illumination detected in the environment (act 1906). By way of example, the learning model 204 determines that the environment is illuminated with mixed illumination based on the determined output frequencies of the illumination sources. For instance, the learning model 204 determines that the two or more illumination sources have different output frequencies. The panoramic imaging module 218 guides adjustment of the orientation and/or location of the mobile device 102 to acquire the panoramic image data 222 as described above with reference to FIGS. 14-16. An angle range based on the preview image data 202 may be determined for the panoramic imaging by the panoramic imaging module 218 as described above. Further, panoramic image data 222 generated during the panoramic imaging may be monitored substantially in real-time as described above.

As one example of the panoramic imaging, the panoramic imaging is initiated with the two or more illumination sources having different output frequencies in the field of view of the image sensor 124. The illumination compensation system 118 displays one or more indicators (e.g., axis 1402, arrow 1404, and/or arrow 1406) to guide movement of the mobile device 102 for panoramic imaging in the angle range. Responsive to detecting that each illumination source depicted in a current image frame (e.g., a most-recently acquired image frame) of the panoramic image data 222 has a same output frequency, the panoramic imaging is paused. The user may be prompted to maintain the mobile device in the position in which the acquisition of the panoramic image data is paused.

As another example of the panoramic imaging, the panoramic imaging proceeds as described above with the mobile device moved by the user while performing the panoramic imaging within the angle range. However, in this example, the panoramic image data is acquired throughout an entirety of the angle range, and the illumination compensation system 118 detects that each image frame in the panoramic image data depicts the environment illuminated by illumination sources that have different output frequencies. In particular, an image frame in which each illumination source has a same output frequency is not detected during the panoramic imaging. As a result, the panoramic imaging is not paused, and the panoramic imaging spans the entire angle range.

As another example of the panoramic imaging, the panoramic imaging is initiated with the mobile device 102 in a position in which the two or more illumination sources are within the field of view of the image sensor 124. The illumination compensation system 118 outputs a prompt (e.g., displays one or more graphical user interface indicators such axis 1402, arrow 1404, and/or arrow 1406, illuminates one or more lights of the mobile device 102, etc.) for the user to move the mobile device 102 in a direction until a first illumination source is within the field of view and a second illumination source is outside the field of view. The first illumination source and the second illumination source have different output frequencies (e.g., emit light at different frequencies relative to each other). In this position, at least one image frame of the panoramic image data 222 is generated. In some instances, while generating the at least one image frame, the flicker sensor 120 is employed by the illumination compensation system 118 to adjust the exposure of the image sensor 124 based on the output frequency of the first illumination source.

Continuing the above example, the illumination compensation system 118 outputs a prompt for the user to move the mobile device 102 in the opposite direction until the second illumination source is within the field of view and the first illumination source is outside the field of view. In this position, at least one additional image frame of the panoramic image data 222 is generated. In some instances, while generating the at least one additional image frame, the flicker sensor 120 is employed by the illumination compensation system 118 to adjust the exposure of the image sensor 124 based on the output frequency of the second illumination source. In this way, the individual image frames generated by the illumination compensation system 118 are compensated for the respective illumination sources depicted by said image frames.

An image that compensates for the mixed illumination is generated from the panoramic imaging (act 1908). By way of example, the output image 226 is generated based at least in part on the panoramic image data 222.

In an example that continues from the example described above in which the panoramic imaging is paused, the output image 226 is generated by imaging the environment via the image sensor 124 at the position at which the panoramic imaging was paused. In this position, each illumination source within the field of view of the image sensor 124 has the same output frequency. As a result, the illumination compensation system 118 can employ the flicker sensor to adjust the exposure of the image sensor 124 based on the output frequency of the depicted illumination sources, and the output image 226 can be generated without banding or other image abnormalities.

In an example that continues from the example described above in which the panoramic imaging is not paused and the panoramic image data is acquired throughout the entirety of the angle range, the output image 226 is generated by compositing one or more image frames of the panoramic image data 222. For instance, the illumination compensation system 118 may determine image frames from the panoramic image data 222 that do not include banding or other image abnormalities and generate the output image 226 by compositing (e.g., combining) the determined image frames.

In an example that continues from the example described above in which one or more image frames are generated depicting the first illumination source and the second illumination source separately, the output image 226 is generated by compositing the image frames. As described above, the image frames depicting the first illumination source and not the second illumination source are generated while the flicker sensor 120 adjusts the exposure of the image sensor 124 based on the output frequency of the first illumination source. The image frames depicting the second illumination source and not the first illumination source are generated while the flicker sensor 120 adjusts the exposure of the image sensor 124 based on the output frequency of the second illumination source. As a result, when the image frames are composited to form the output image 226, the output image 226 does not include banding or other image abnormalities.

FIG. 20 illustrates various components of an example mobile device 2000 in which embodiments of mobile device conditional flicker compensation for mixed lighting conditions can be implemented. The mobile device 2000 can be implemented as any of the devices described with reference to the previous FIG. s, such as any type of client device, mobile phone, tablet, computing, communication, entertainment, gaming, media playback, or other type of electronic device. In one or more embodiments the mobile device 2000 is a mobile device 102 and the illumination compensation system 2028 includes the illumination compensation system 118, described above.

The mobile device 2000 includes one or more data input components 2002 via which any type of data, media content, or inputs can be received such as user-selectable inputs, messages, music, television content, recorded video content, and any other type of text, audio, video, or image data received from any content or data source. The data input components 2002 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 2002 may also include various other input components such as microphones, touch sensors, touchscreens, keyboards, and so forth.

The mobile device 2000 includes communication transceivers 2004 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The mobile device 2000 includes a processing system 2006 of one or more processors (e.g., any of microprocessors, controllers, and the like) or a processor and memory system implemented as a system-on-chip (SoC) that processes computer-executable instructions. The processing system 2006 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 2008. The mobile device 2000 may further include any type of a system bus or other data and command transfer system that couples the various components within the device. A system bus can include any one or combination of different bus structures and architectures, as well as control and data lines.

The mobile device 2000 also includes computer-readable storage memory devices 2010 that enable data storage, such as data storage devices that can be accessed by an electronic device, and that provide persistent storage of data and executable instructions (e.g., software applications, programs, functions, and the like). Examples of the computer-readable storage memory devices 2010 include volatile memory and non-volatile memory, fixed and removable media devices, and any suitable memory device or electronic data storage that maintains data for electronic device access. The computer-readable storage memory can include various implementations of random access memory (RAM), read-only memory (ROM), flash memory, and other types of storage media in various memory device configurations. The mobile device 2000 may also include a mass storage media device.

The computer-readable storage memory device 2010 provides data storage mechanisms to store the device data 2012, other types of information or data, and various device applications 2014 (e.g., software applications). For example, an operating system 2016 can be maintained as software instructions with a memory device and executed by the processing system 2006. The device applications 2014 may also include a device manager, such as any form of a control application, software application, signal-processing and control module, code that is native to a particular device, a hardware abstraction layer for a particular device, and so on.

The mobile device 2000 can also include one or more device sensors 2018, such as any one or more of an ambient light sensor, a proximity sensor, a touch sensor, an infrared (IR) sensor, accelerometer, gyroscope, thermal sensor, audio sensor (e.g., microphone), and the like. The mobile device 2000 can also include one or more power sources 2020, such as when the mobile device 2000 is implemented as a mobile device. The power sources 2020 may include a charging or power system, and can be implemented as a flexible strip battery, a rechargeable battery, a charged super-capacitor, or any other type of active or passive power source.

The mobile device 2000 additionally includes an audio or video processing system 2022 that generates one or both of audio data for an audio system 2024 and display data for a display system 2026. In accordance with some embodiments, the audio/video processing system 2022 is configured to receive call audio data from the transceiver 2004 and communicate the call audio data to the audio system 2024 for playback at the mobile device 2000. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for mobile device conditional flicker compensation for mixed lighting conditions have been described in language specific to features or methods, the subject of the appended claims is not necessarily limited to the specific features or methods described. Rather, the specific features and methods are disclosed as example implementations of techniques for implementing mobile device conditional flicker compensation for mixed lighting conditions. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a mobile device, including: at least one memory; and at least one processor coupled with the at least one memory and configured to cause the mobile device to: acquire data describing an environment of the mobile device; process the data using at least one machine-learning model trained to detect mixed illumination in the environment, the mixed illumination including light emitted by two or more illumination sources at different output frequencies; initiate panoramic imaging based at least in part on the mixed illumination detected in the environment; and generate an image that compensates for the mixed illumination from the panoramic imaging.

In some aspects, the techniques described herein relate to a mobile device, wherein the data describing the environment includes preview image data acquired via an image sensor of the mobile device.

In some aspects, the techniques described herein relate to a mobile device, wherein, while processing the data describing the environment, the at least one machine-learning model identifies the two or more illumination sources depicted in the preview image data.

In some aspects, the techniques described herein relate to a mobile device, wherein processing the data includes determining the different output frequencies of each of the two or more illumination sources using the at least one machine-learning model.

In some aspects, the techniques described herein relate to a mobile device, wherein the at least one processor is configured to cause the mobile device to display a user interface for the panoramic imaging based on a content of the data describing the environment.

In some aspects, the techniques described herein relate to a mobile device, wherein the user interface includes one or more indicators to guide movement of the mobile device based on respective locations of the two or more illumination sources within the environment.

In some aspects, the techniques described herein relate to a mobile device, wherein the at least one processor is configured to cause the mobile device to: acquire panoramic image data in an angle range via an image sensor of the mobile device during the panoramic imaging, the angle range based on the data describing the environment, the panoramic image data including one or more image frames; and monitor the panoramic image data in real-time for an image frame of the one or more image frames in which each depicted illumination source has a same output frequency.

In some aspects, the techniques described herein relate to a mobile device, wherein the at least one processor is configured to cause the mobile device to: generate the image that compensates for the mixed illumination by compositing the one or more image frames responsive to acquiring the panoramic image data throughout an entirety of the angle range and detecting that each image frame of the one or more image frames depicts the environment illuminated by illumination sources having different output frequencies.

In some aspects, the techniques described herein relate to a mobile device, wherein the at least one processor is configured to cause the mobile device to: pause the panoramic imaging responsive to detecting the image frame of the one or more image frames in which each depicted illumination source has the same output frequency.

In some aspects, the techniques described herein relate to a mobile device, wherein the at least one processor is configured to cause the mobile device to: generate the image that compensates for the mixed illumination based on the image frame while the mobile device is maintained in a position in which the panoramic imaging is paused.

In some aspects, the techniques described herein relate to a mobile device, wherein the at least one processor is configured to cause the mobile device to: acquire a first image with a first illumination source of the two or more illumination sources within a field of view of an image sensor of the mobile device during the panoramic imaging; acquire a second image with a second illumination source of the two or more illumination sources within the field of view and the first illumination source outside the field of view during the panoramic imaging; and generate the image that compensates for the mixed illumination by compositing the first image and the second image.

In some aspects, the techniques described herein relate to a mobile device, wherein the at least one processor is configured to cause the mobile device to: adjust an exposure of the image sensor based on an output frequency of the first illumination source while acquiring the first image; and adjust an exposure of the image sensor based on an output frequency of the second illumination source while acquiring the second image.

In some aspects, the techniques described herein relate to a mobile device, wherein adjusting the exposure of the image sensor based on the output frequency of the first illumination source and adjusting the exposure of the image sensor based on the output frequency of the second illumination source is performed using a flicker sensor of the mobile device.

In some aspects, the techniques described herein relate to a method performed by a mobile device, the method including: acquiring data describing an environment of the mobile device; processing the data using at least one machine-learning model trained to detect mixed illumination in the environment, the mixed illumination including light emitted by two or more illumination sources at different output frequencies; initiating panoramic imaging based at least in part on the mixed illumination detected in the environment; and generating an image that compensates for the mixed illumination from the panoramic imaging.

In some aspects, the techniques described herein relate to a method, wherein the data describing the environment includes preview image data acquired via an image sensor of the mobile device, and processing the data causes the at least one machine-learning model to identify the two or more illumination sources depicted in the preview image data.

In some aspects, the techniques described herein relate to a method, further including: acquiring panoramic image data in an angle range via an image sensor of the mobile device during the panoramic imaging, the angle range based on the data describing the environment, the panoramic image data including one or more image frames; and pausing the panoramic imaging responsive to detecting an image frame of the one or more image frames in which each depicted illumination source has a same output frequency.

In some aspects, the techniques described herein relate to a method, further including: acquiring a first image with a first illumination source of the two or more illumination sources within a field of view of an image sensor of the mobile device during the panoramic imaging; acquiring a second image with a second illumination source of the two or more illumination sources within the field of view and the first illumination source outside the field of view during the panoramic imaging; and generating the image that compensates for the mixed illumination by compositing the first image and the second image.

In some aspects, the techniques described herein relate to a system, including: an image sensor; at least one memory; and at least one processor coupled with the at least one memory and configured to cause the system to: acquire data describing an environment; process the data using at least one machine-learning model trained to detect mixed illumination in the environment, the mixed illumination including light emitted by two or more illumination sources at different output frequencies; initiate panoramic imaging using the image sensor based at least in part on the mixed illumination detected in the environment; and generate an image that compensates for the mixed illumination from the panoramic imaging.

In some aspects, the techniques described herein relate to a system, wherein the data describing the environment is preview image data acquired via the image sensor at a first pixel resolution, and the at least one processor is further configured to cause the system to: identify illumination sources in the environment depicted by the preview image data via the at least one machine-learning model; and generate the image that compensates for the mixed illumination at a second pixel resolution, the second pixel resolution being greater than the first pixel resolution.

In some aspects, the techniques described herein relate to a system, wherein the at least one processor is further configured to cause the system to: generate the image that compensates for the mixed illumination from panoramic image data acquired in an angle range during the panoramic imaging, the angle range determined based on the preview image data and the illumination sources in the environment.

What is claimed is:

1. A mobile device, comprising:
at least one memory; and
at least one processor coupled with the at least one memory and configured to cause the mobile device to:
acquire data describing an environment of the mobile device;
process the data using at least one machine-learning model trained to detect mixed illumination in the environment, the mixed illumination including light emitted by two or more illumination sources at different output frequencies;
initiate panoramic imaging based at least in part on the mixed illumination detected in the environment; and
generate an image that compensates for the mixed illumination from the panoramic imaging.

2. The mobile device of claim 1, wherein the data describing the environment includes preview image data acquired via an image sensor of the mobile device.

3. The mobile device of claim 2, wherein, while processing the data describing the environment, the at least one machine-learning model identifies the two or more illumination sources depicted in the preview image data.

4. The mobile device of claim 1, wherein processing the data includes determining the different output frequencies of each of the two or more illumination sources using the at least one machine-learning model.

5. The mobile device of claim 1, wherein the at least one processor is configured to cause the mobile device to display a user interface for the panoramic imaging based on a content of the data describing the environment.

6. The mobile device of claim 5, wherein the user interface includes one or more indicators to guide movement of the mobile device based on respective locations of the two or more illumination sources within the environment.

7. The mobile device of claim 1, wherein the at least one processor is configured to cause the mobile device to:
acquire panoramic image data in an angle range via an image sensor of the mobile device during the panoramic imaging, the angle range based on the data describing the environment, the panoramic image data including one or more image frames; and
monitor the panoramic image data in real-time for an image frame of the one or more image frames in which each depicted illumination source has a same output frequency.

8. The mobile device of claim 7, wherein the at least one processor is configured to cause the mobile device to:
generate the image that compensates for the mixed illumination by compositing the one or more image frames responsive to acquiring the panoramic image data throughout an entirety of the angle range and detecting that each image frame of the one or more image frames depicts the environment illuminated by illumination sources having different output frequencies.

9. The mobile device of claim 7, wherein the at least one processor is configured to cause the mobile device to:
pause the panoramic imaging responsive to detecting the image frame of the one or more image frames in which each depicted illumination source has the same output frequency.

10. The mobile device of claim 9, wherein the at least one processor is configured to cause the mobile device to:
generate the image that compensates for the mixed illumination based on the image frame while the mobile device is maintained in a position in which the panoramic imaging is paused.

11. The mobile device of claim 1, wherein the at least one processor is configured to cause the mobile device to:
acquire a first image with a first illumination source of the two or more illumination sources within a field of view of an image sensor of the mobile device during the panoramic imaging;
acquire a second image with a second illumination source of the two or more illumination sources within the field of view and the first illumination source outside the field of view during the panoramic imaging; and
generate the image that compensates for the mixed illumination by compositing the first image and the second image.

12. The mobile device of claim 11, wherein the at least one processor is configured to cause the mobile device to:
adjust an exposure of the image sensor based on an output frequency of the first illumination source while acquiring the first image; and
adjust an exposure of the image sensor based on an output frequency of the second illumination source while acquiring the second image.

13. The mobile device of claim 12, wherein adjusting the exposure of the image sensor based on the output frequency of the first illumination source and adjusting the exposure of the image sensor based on the output frequency of the second illumination source is performed using a flicker sensor of the mobile device.

14. A method performed by a mobile device, the method comprising:
acquiring data describing an environment of the mobile device;
processing the data using at least one machine-learning model trained to detect mixed illumination in the environment, the mixed illumination including light emitted by two or more illumination sources at different output frequencies;
initiating panoramic imaging based at least in part on the mixed illumination detected in the environment; and
generating an image that compensates for the mixed illumination from the panoramic imaging.

15. The method of claim 14, wherein the data describing the environment includes preview image data acquired via an image sensor of the mobile device, and processing the data causes the at least one machine-learning model to identify the two or more illumination sources depicted in the preview image data.

16. The method of claim 14, further comprising:
acquiring panoramic image data in an angle range via an image sensor of the mobile device during the panoramic imaging, the angle range based on the data describing the environment, the panoramic image data including one or more image frames; and
pausing the panoramic imaging responsive to detecting an image frame of the one or more image frames in which each depicted illumination source has a same output frequency.

17. The method of claim 14, further comprising:
acquiring a first image with a first illumination source of the two or more illumination sources within a field of view of an image sensor of the mobile device during the panoramic imaging;
acquiring a second image with a second illumination source of the two or more illumination sources within the field of view and the first illumination source outside the field of view during the panoramic imaging; and
generating the image that compensates for the mixed illumination by compositing the first image and the second image.

18. A system, comprising:
an image sensor;
at least one memory; and
at least one processor coupled with the at least one memory and configured to cause the system to:
acquire data describing an environment;
process the data using at least one machine-learning model trained to detect mixed illumination in the environment, the mixed illumination including light emitted by two or more illumination sources at different output frequencies;
initiate panoramic imaging using the image sensor based at least in part on the mixed illumination detected in the environment; and
generate an image that compensates for the mixed illumination from the panoramic imaging.

19. The system of claim 18, wherein the data describing the environment is preview image data acquired via the image sensor at a first pixel resolution, and the at least one processor is further configured to cause the system to:
identify illumination sources in the environment depicted by the preview image data via the at least one machine-learning model; and
generate the image that compensates for the mixed illumination at a second pixel resolution, the second pixel resolution being greater than the first pixel resolution.

20. The system of claim 19, wherein the at least one processor is further configured to cause the system to:
generate the image that compensates for the mixed illumination from panoramic image data acquired in an angle range during the panoramic imaging, the angle range determined based on the preview image data and the illumination sources in the environment.
